(19) United States
(12) Patent Application Publication
(10) Pub. No.: US 2026/0034499 A1
(43) Pub. Date: Feb. 5, 2026

(54) SYSTEMS AND METHODS FOR RADIAL FLOW, STEAM-ASSISTED, TEMPERATURE-VACUUM SWING DIRECT AIR CAPTURE OF CARBON DIOXIDE

(71) Applicant: Octavia Carbon Co., Middletown, DE (US)

(72) Inventors: Huzeifa Munaver Pothiwalla, Nairobi (KE); Earl Spencer Mogire, Mlolongo (KE); Mike Bwondera, Nairobi (KE); Duncan Kariuki, Nairobi (KE); Areeb Ahmed, Nairobi (KE)

(21) Appl. No.: 19/288,250

(22) Filed: Aug. 1, 2025

Related U.S. Application Data
(60) Provisional application No. 63/679,589, filed on Aug. 5, 2024.

(51) Int. Cl. B01D 53/04

(52) U.S. Cl. CPC B01D 53/0462; B01D 2257/504; B01D 2258/06; B01D 2259/40009; B01D 2259/40028

(57) ABSTRACT

A direct air capture (DAC) system includes: a sorbent chamber housing a set of sorbent beds; a conductive heating subsystem; and a purging subsystem. The sorbent beds: arrange vertically within the sorbent chamber; define a set of radial interstices between vertically adjacent sorbent beds; and extend radially about a vertical manifold defining a set of manifold apertures. The conductive heating subsystem includes a set of thermally conductive heating coils arranged within a sorbent bed in the set of sorbent beds; and configured to circulate a thermally conductive heating fluid to heat the sorbent bed. The purging subsystem includes a set of purging coils configured to distribute a purging fluid via a set of purging nozzles to a sorbent bed; and arranged above the sorbent bed.

### CROSS REFERENCE TO RELATED APPLICATIONS

This application claims priority to the U.S. Provisional Application No. 63/679,589, filed on 5 Aug. 2024, which is incorporated in its entirety by this reference.

### TECHNICAL FIELD

This invention relates generally to the field of direct air capture of carbon dioxide and, more specifically, to new and useful systems and methods for radial flow, steam-assisted, temperature-vacuum swing direct air capture of carbon dioxide in the field of direct air capture of carbon dioxide.

### BRIEF DESCRIPTION OF THE FIGURES

FIG. 1A is a cut-away view of one variation of a system for radial flow, steam-assisted, temperature-vacuum swing direct air capture of carbon dioxide;

FIG. 1B is a top-down view of one variation of a system for radial flow, steam-assisted, temperature-vacuum swing direct air capture of carbon dioxide;

FIG. 2 is a flowchart representation of one variation of a method for direct air capture of carbon dioxide;

FIG. 3 is a flowchart representation of one variation of a method for direct air capture of carbon dioxide;

FIG. 4A is a flowchart representation of one variation of a method for direct air capture of carbon dioxide;

FIG. 4B is a flowchart representation of one variation of a method for direct air capture of carbon dioxide;

FIG. 4C is a flowchart representation of one variation of a method for direct air capture of carbon dioxide;

FIG. 5 is a schematic representation of one variation of fluid flow through the sorbent chamber;

FIG. 6 is a schematic representation of one variation of the system including a set of sorbent modules;

FIG. 7 is a schematic representation of one variation of a thermally conductive heating coil in a set of thermally conductive heating coils;

FIG. 8 is a schematic representation of one variation of a set of purging coils;

FIG. 9 is a schematic representation of one variation of the sorbent support structure;

FIG. 10 is a representation of one variation of the DAC system; and

FIG. 11 is a block diagram representation of one variation of the DAC system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

Generally, the term “can,” as utilized herein, indicates an action or attribute of the system, which may or may not be executed by or be applicable to the system depending on the implementation or embodiment of the system.

Generally, the term “include,” as utilized herein, can mean “comprise,” “consist of,” or “consist essentially of,” and is not restricted to any one of the above interpretations throughout.

Generally, the term “set,” as utilized herein, can include a single instance or multiple instances of an associated object. Descriptors such as “first,” “second,” “third,” etc., as utilized herein, do not imply a sequence or order unless otherwise specified but do imply separate instances of the associated object.

Generally, the term “fluid,” as utilized herein, refers to either a gas or liquid. Additionally, the term “fluidically coupled,” as utilized herein, indicates continuity of fluid flow between “fluidically coupled” components.

Generally, the term “purging fluid,” as utilized herein, refers to a fluid, initially in a gaseous phase, utilized by the purging subsystem to facilitate the desorption of carbon dioxide from the sorbent material and the removal of other gases from the sorbent chamber. In some implementations described below, steam is utilized as the purging fluid. In these implementations, the term “steam” may be utilized interchangeably with “purging fluid.” Thus, implementations described as utilizing steam in the context of purging may utilize any other purging fluid.

Similarly, the term “thermally conductive heating fluid,” as utilized herein, refers to a fluid utilized by the conductive heating subsystem to transfer heat to the sorbent material within the sorbent bed. In some implementations described below, steam is utilized as the thermally conductive heating fluid. In these implementations, the term “steam” may be utilized interchangeably with “thermally conductive heating fluid.” Thus, implementations described as utilizing “steam” in the context of thermal conduction may utilize any other thermally conductive heating fluid.

Generally, the term “sorbent bed,” as utilized herein, refers to the component of the direct air capture system configured to hold a layer of a sorbent material or a “sorbent layer.”

Generally, the system described herein includes an inlet duct through which a blower moves a flow of gas through an inlet damper and into the sorbent chamber. Generally, the blower, inlet duct, and inlet damper are configured to only circulate flow in the direction from the blower to the inlet damper. As such, the term “upstream,” as utilized herein, refers to an arrangement of a component of the direct air capture system that is situated in the path of flow before another component. For example, the blower is arranged upstream of the inlet damper. Likewise, the term “downstream,” as utilized herein, refers to an arrangement of a component of the direct air capture system that is situated in the path of flow after another component.

### 1. Direct Air Capture System

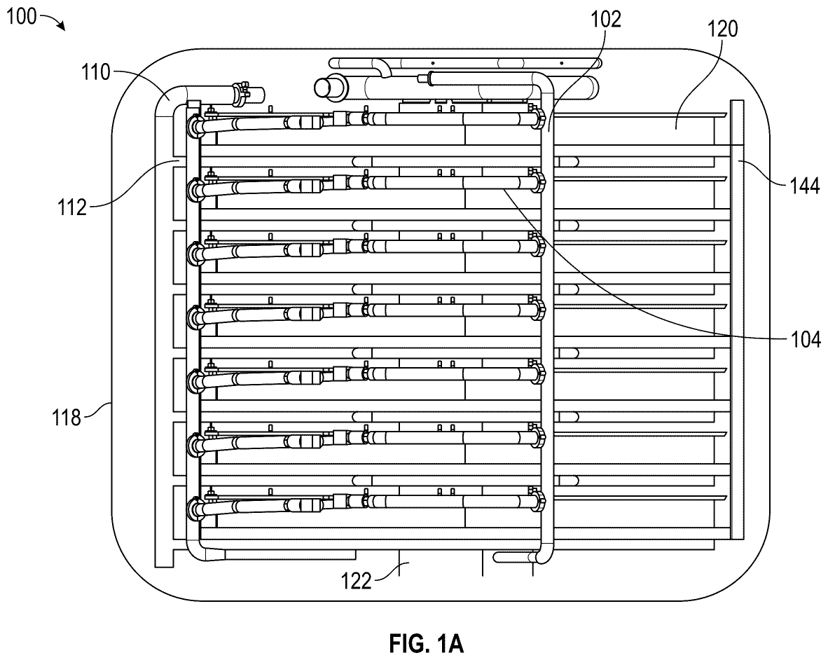

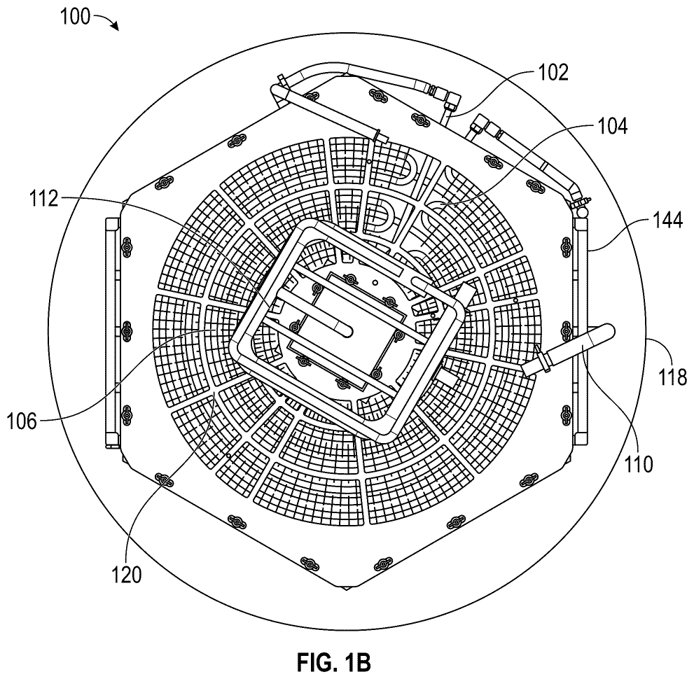

As shown in FIGS. 1A and 1B, a DAC system 100 includes: a sorbent chamber 118 housing a set of sorbent beds; a conductive heating subsystem 102; and a purging subsystem 110. The set of sorbent beds 120: is arranged vertically within the sorbent chamber 118; and defines a set of radial interstices between vertically adjacent sorbent beds in the set of sorbent beds 120. Additionally, each sorbent bed in the set of sorbent beds extends radially about a vertical manifold 122, whereby the vertical manifold defines a set of manifold apertures 128, each manifold aperture in the set of manifold apertures 128 fluidically connecting the vertical manifold 122 to a radial interstice in the set of radial interstices 124. The conductive heating subsystem includes a set of thermally conductive heating coils 104 arranged within the sorbent chamber 118, each thermally conductive heating coil 104 in the set of thermally conductive heating coils 104: arranged within a sorbent bed 120 in the set of sorbent beds 120; and configured to circulate a thermally conductive heating fluid 108 to heat the sorbent bed. The purging subsystem 110 includes a set of purging coils 112, each purging coil: configured to distribute a purging fluid 116 via a set of purging nozzles 114 to a sorbent bed 120 in the set of sorbent beds 120; and arranged above the sorbent bed 120 in the set of sorbent beds 120.

### 2. Variation: Sorbent Modules

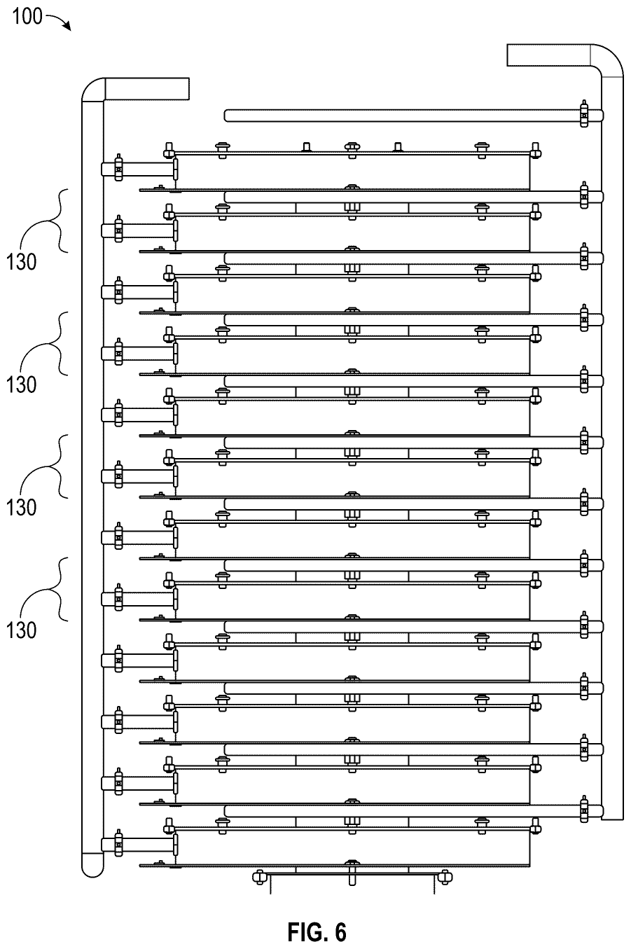

As shown in FIG. 6, in one implementation, the DAC system 100 includes a set of sorbent modules 130, each sorbent module 130 including: a sorbent bed; a purging coil; and a thermally conductive heating coil. In this variation, the DAC system 100 comprises: a conductive heating subsystem; a purging subsystem 110; and a sorbent chamber 118 enclosing a set of sorbent modules. The conductive heating subsystem includes a set of thermally conductive heating coils 104. The purging subsystem 110 includes a set of purging coils 112 configured to distribute a purging fluid 116 via a set of purging nozzles 114. The sorbent chamber 118 encloses a set of sorbent modules 130: vertically arranged within the sorbent chamber 118; defining a vertical manifold 122 and a set of radial interstices between vertically adjacent sorbent modules in the set of sorbent modules 130; and extending radially from the vertical manifold 122. Each sorbent module 130 in the set of sorbent modules 130 includes: a vertical manifold 122 segment of the vertical manifold 122 defining a set of manifold apertures 128 fluidically connecting the vertical manifold 122 to a radial interstice in the set of radial interstices 124; a sorbent bed 120 extending radially from the vertical manifold 122 segment and associated with a purging coil 112 in the set of purging coils 112 configured to distribute the purging fluid 116 into the sorbent bed; and a thermally conductive heating coil 104 in the set of thermally conductive heating coils 104 arranged within the sorbent bed.

### 3. Applications

Generally, the direct air capture system (hereinafter “the DAC system”) executes a variation of steam-assisted, temperature-vacuum swing direct air capture of dioxide capture (hereinafter “s-TVSA”) that improves the energy and sorbent efficiency of s-TVSA by reducing the pressure drop across the sorbent chamber 118 and by increasing in the volume density of the sorbent within the sorbent chamber 118 relative to existing s-TVSA technologies. Additionally, the DAC system 100 improves sorbent durability by reducing the quantity of condensation within the sorbent chamber 118 and by facilitating drainage of any condensation produced within the sorbent chamber 118. Furthermore, the DAC system 100 facilitates maintenance and sorbent replacement in the sorbent chamber 118 via a modular design. Thus, the DAC system 100 enhances the viability of carbon dioxide removal on a gigaton scale by decreasing energy, sorbent, and maintenance costs per unit of carbon dioxide removed.

More specifically, the DAC system 100 provides these improvements via a set of sorbent beds stacked vertically within the sorbent chamber 118 to form a radial flow pattern for inlet gas containing carbon dioxide. Each sorbent bed 120 contains a thin sorbent layer (e.g., 15-30 millimeters in depth), which enables the inlet gas to penetrate the sorbent layer at lower pressure differentials. Due to the radial flow pattern, gas may exit the sorbent chamber 118 upon passing through a single sorbent bed 120 (e.g., a single sorbent layer), thereby decreasing the overall pressure drop across the sorbent chamber 118 (relative to serial sorbent bed 120 designs that force inlet gas through multiple sorbent beds) and enabling tighter vertical spacing between sorbent beds.

Additionally, the DAC system 100 can include a purging coil 112 (for direct steam purging into the sorbent beds) and a thermally conductive coil arranged adjacent to or integrated with each sorbent bed 120 in the sorbent chamber 118 to directly preheat the sorbent, thereby preventing steam from condensing within the sorbent layer during purging. Thus, the DAC system 100 includes specific design features that affect the aforementioned improvements relative to prior s-TVSA designs.

In one application, the DAC system 100 is utilized to scale direct air capture of atmospheric carbon dioxide. In this application, multiple instances of the DAC system 100 can be installed at a favorable site and operated simultaneously to remove carbon dioxide from atmospheric air at a rate greater than one kilogram of carbon dioxide per instance of the DAC system 100.

In another application, the DAC system 100 is utilized to extract carbon dioxide from flue gas or any other source of gas containing high concentrations of carbon dioxide. In this application, the DAC system 100 can utilize alternative sorbents that are more efficient at higher carbon dioxide concentrations and can include other modifications to accommodate differences in temperature, pressure, and/or chemical composition of the inlet gas when compared to atmospheric air.

### 4. DAC System Overview

Generally, the DAC system 100 is configured to: received a flow of inlet gas containing carbon dioxide; absorb a portion of the carbon dioxide within the flow of inlet gas via the set of sorbent beds 120; desorb carbon dioxide from the set of sorbent beds 120; and release a flow of outlet gas rich in carbon dioxide. The DAC system 100 executes this method via a set of phases including: a sorption phase S102 in which carbon dioxide of the inlet gas is absorbed by the set of sorbent beds 120; a vacuum-heating phase S104 during which the conductive heating subsystem 102 heats the set of sorbent beds 120; and a desorption phase S106 during which the purging subsystem 110 circulates and distributes purging fluid 116 toward the sorbent beds.

Generally, the DAC system 100 includes: a set of sorbent beds arranged within a sorbent chamber 118; a conductive heating subsystem 102 configured to heat the set of sorbent beds 120; and a purging subsystem 110 configured to purge carbon dioxide from the set of sorbent beds 120. More specifically, the DAC system 100 can additionally include: a sorbent chamber 118; an inlet damper 132; an outlet damper 138; a set of carbon dioxide sensors; a blower 142; an inlet duct 140; and outlet duct; a depressurization subsystem 148; a recovery subsystem 150; and a control subsystem 152. Each of these components, subsystems, and variants thereof of the DAC system 100 are described below.

### 5. Conductive Heating Subsystem

Generally, the DAC system 100 includes a conductive heating subsystem 102 further including a set of thermally conductive heating coils 104 integrated into sorbent beds within the sorbent chamber 118. More specifically, each thermally conductive heating coil 104 in the set of thermally conductive heating coils 104 is: arranged within a sorbent bed 120 in the set of sorbent beds 120; and configured to circulate a thermally conductive heating fluid 108 to heat the sorbent bed. The conductive heating subsystem 102 integrates with the sorbent beds to heat the sorbent layer within each sorbent bed 120 of the sorbent chamber 118. In one implementation, the conductive heating subsystem 102 heats the sorbent to a temperature above a saturation temperature of the purging fluid 116 at the desorption pressure. Thus, the conductive heating subsystem 102 prevents condensation from forming within the sorbent beds during the desorption phase S106 of the s-TVSA. The integration of the thermally conductive heating coils into the sorbent beds thereby enables high-yield purging and increases sorbent longevity.

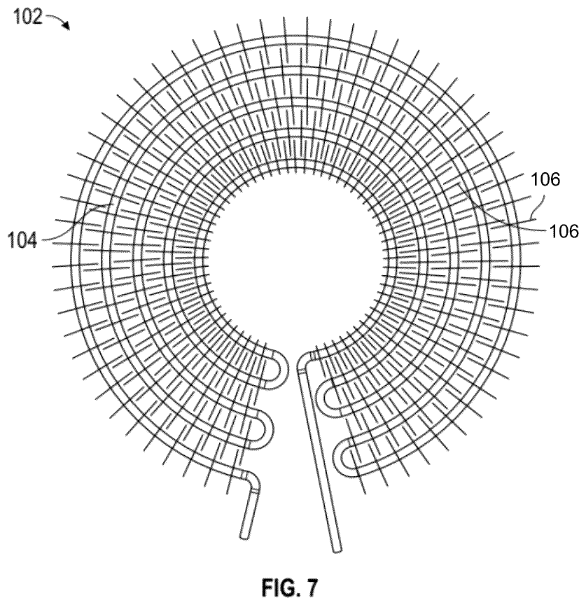

In one implementation, as shown in FIG. 7, each thermally conductive heating coil 104 in the set of thermally conductive heating coils 104 is characterized by a closed-path-radial-serpentine geometry. In this implementation, the set of thermally conductive heating coils 104 can include a set of vertically stacked conductive heating coils exhibiting the closed-path-radial-serpentine geometry, wherein each thermally conductive heating coil 104 is arranged integrated within, abutting, above, or below a sorbent bed 120 in the set of sorbent beds 120. However, the set of thermally conductive heating coils 104 may exhibit any other arrangement or geometry that enables even heat distribution about the set of sorbent beds 120.

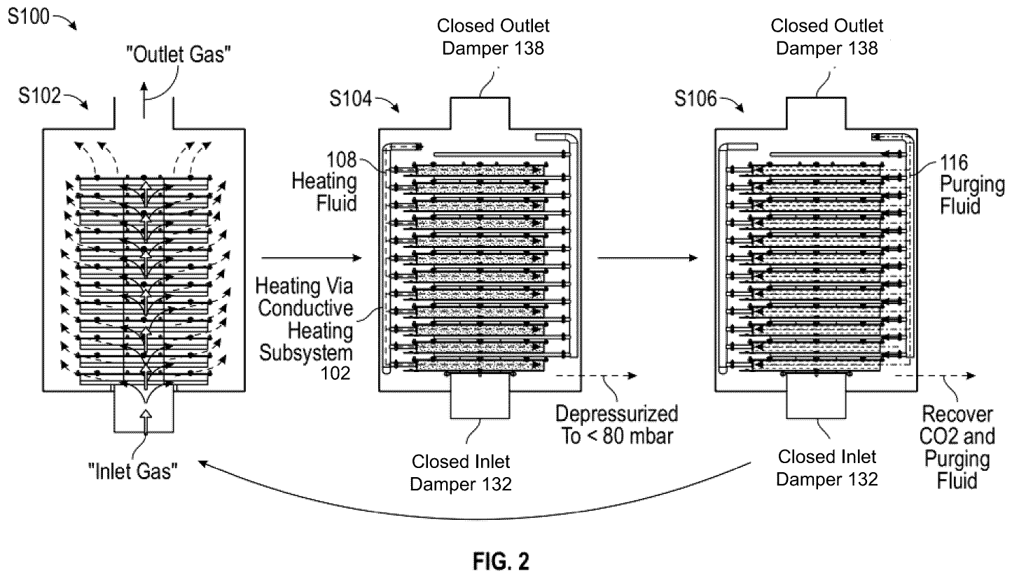

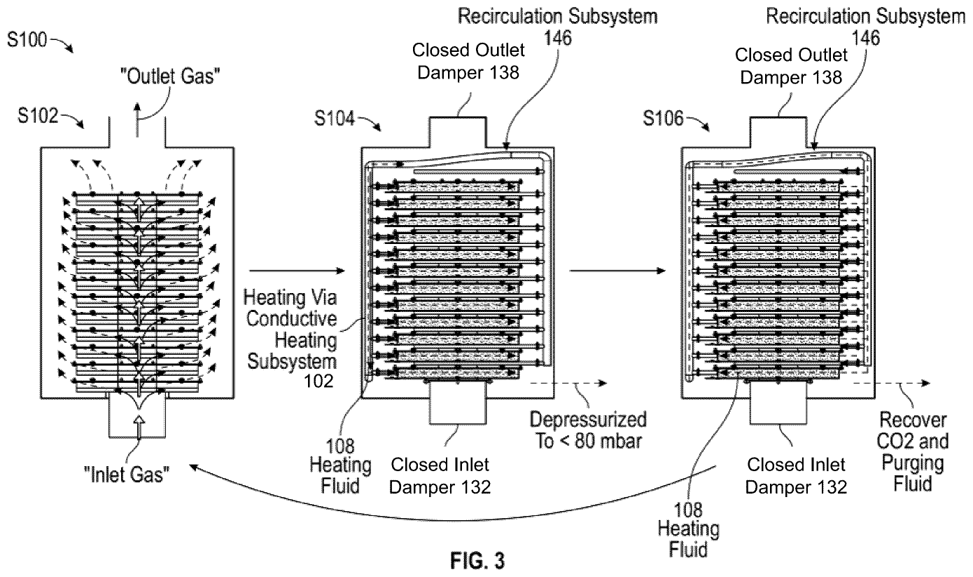

As shown in FIG. 2, in one implementation, the set of thermally conductive heating coils 104 includes a set of pipes (e.g., constructed from a thermally conductive material such as aluminum 6061) configured to circulate a thermally conductive heating fluid 108 to continuously transfer heat to the sorbent layers via conduction and/or radiation. In another implementation, shown in FIG. 3, the thermally conductive heating coils include a set of pipes configured to circulate the purging fluid 116 (e.g., steam or the fluid utilized by the purging subsystem 110 to purge the sorbent beds of carbon dioxide) as the thermally conductive heating fluid 108. For example, the thermally conductive heating coils 104 are configured to circulate steam, while the purging coils 112 of the purging subsystem 110 are configured to circulate and expel steam through purging nozzles 114. During a vacuum-heating phase S104 executed by a control subsystem 152 of the DAC system 100, the conductive heating subsystem 102 circulates a flow of steam through the thermally conductive heating coils to heat the sorbent. During a desorption stage that can follow, overlap with, or occur simultaneously with the vacuum-heating phase S104, the purging subsystem 110 circulates a flow of steam through the purging coils and out of the purging nozzles 114 to purge carbon dioxide from the sorbent chamber. In one implementation, the flow of steam circulated through the thermally conductive heating coils by the conductive heating subsystem 102 is the same flow of steam circulated through the purging coils by the purging subsystem 110. For example, the flow of steam can be recirculated between the conductive heating subsystem 102 and purging subsystem by a control subsystem 152 of the DAC system 100. However, the set of thermally conductive heating coils 104 can be configured to transfer any fluid suitable for heat transfer to the set of sorbent beds 120 via conduction.

In implementations in which the set of thermally conductive heating coils 104 is configured to circulate a thermally conductive heating fluid 108, the conductive heating subsystem 102 can include a heat source such as a heat exchanger or set of electrical heating elements to impart heat energy to the thermally conductive heating fluid 108. In one example, the set of thermally conductive heating coils 104 receives thermal energy from a geothermal heat source. In another example, the set of thermally conductive heating coils 104 receives thermal energy from the recovery subsystem 150 further described below. In yet another example, the conductive heating subsystem 102 receives thermal energy from some combination of the above sources. In yet another example, the set of thermally conductive heating coils 104 receives thermal energy from an electrically powered steam boiler, a geothermal heat source, and/or the recovery subsystem 150. However, the thermally conductive heating coils can receive heat from any other viable heat source.

In one implementation, the conductive heating subsystem 102 includes a set of electrical (i.e., resistive) heating elements as the set of thermally conductive heating coils 104. The set of electrical heating elements can impart heat to the set of sorbent layers within the set of sorbent beds 120 via an electrical current passed through the set of electrical heating elements.

In one implementation, the conductive heating subsystem 102 can include sealed entry ports in the sorbent chamber 118 to enable the thermally conductive heating coils to transfer heat (in the form of thermally conductive heating fluid 108 or an electrical current) into the sorbent chamber 118 from a heat source outside of the sorbent chamber 118.

In one implementation, the conductive heating subsystem 102 can further include a fluid circulation pump configured to circulate the thermally conductive heating fluid 108 through the set of thermally conductive heating coils 104. The fluid circulation pump can be arranged outside of the sorbent chamber 118 to preserve function of the pump and can feature couplings to the sealed entry and exit points from the sorbent chamber 118. The fluid circulation pump is thereby enabled to pump thermally conductive heating fluid 108 into an inlet of a set of thermally conductive heating coils 104 and receive a flow of thermally conductive heating fluid 108 from an outlet of the set of thermally conductive coils.

In yet another implementation, the conductive heating subsystem 102 includes mechanically or electromechanically actuated couplers to enable the removal of a subset of thermally conductive heating coils 104 from the sorbent chamber 118. In this implementation, a user may decouple a corresponding subset of couplers linking the subset of thermally conductive heating coils 104 to the exterior components of the conductive heating subsystem 102. However, the DAC system 100 can include electromechanical couplers or any other form of coupler to enable the removal of a subset of thermally conductive heating coils 104 from the sorbent chamber 118.

In yet another implementation, the conductive heating subsystem 102 can include thermally conductive heating coils between 1.0 and 2.0 cm in diameter to minimize the resistance to inlet gas flow through the sorbent beds.

In one implementation, the conductive heating system can additionally include a set of thermally conductive fins 106 (e.g., manufactured from a thermally conductive material such as aluminum 6061) configured to distribute thermal energy from the set of thermally conductive heating coils. In one implementation, each thermally conductive fin 106 in the set of thermally conductive fins 106 is: arranged within a sorbent bed 120 in the set of sorbent beds 120; and configured to distribute thermal energy to the sorbent bed 120 in the set of sorbent beds 120. However, the set of thermally conductive fins 106 can include a subset of thermally conductive fins 106 integrated within or abutting a first subset of sorbent beds of the set of sorbent beds 120 and a second subset of thermally conductive fins 106 not integrated within or abutting the subset of sorbent beds. Therefore, the set of thermally conductive fins 106 can distribute thermal energy from the thermally conductive heating fluid 108 within the thermally conductive heating coils to the set of sorbent beds 120 and around the sorbent chamber 118 to improve thermal energy distribution, thereby preventing uneven heating of sorbent beds. In one implementation, the set of thermally conductive fins 106 defines a narrow, elongated geometry such as a wire. For example, a thermally conductive fin 106 of the set of thermally conductive fins 106 can exhibit a height of 1 cm to 5 cm and a length of 8 cm to 12 cm. In one implementation, a thermally conductive fin 106 of the set of thermally conductive fins can include an elongated or elliptical bore characterized by a diameter between 2.1 cm and 2.3 cm. The bore is configured to enable a thermally conductive heating coil of the set of thermally conductive heating coils to traverse through the thermally conductive fin, thereby enabling direct heating of the thermally conductive fin by the thermally conductive heating coil. However, the thermally conductive fins may also be characterized by any other geometry or dimension allowing for thermal energy distribution about the sorbent beds, such as airfoils or curves.

In one implementation, the set of thermally conductive fins 106 is manufactured of the same material as the set of thermally conductive heating coils 104 (e.g., aluminum 6061). However, the set of thermally conductive fins 106 can be manufactured with any other thermally conductive material. In one implementation, the set of thermally conductive fins 106 is coupled to the set of thermally conductive coils via a thermally conductive coupling such as a weld. However, the set of thermally conductive fins 106 may be detached from the set of thermally conductive heating coils 104. For example, the set of thermally conductive fins 106 can be embedded within the set of sorbent beds 120 but separate from the set of thermally conductive heating coils 104.

In one implementation, as shown in FIG. 7, the set of thermally conductive fins 106 is arranged in a radial pattern about the thermally conductive coils. For example, each thermally conductive fin 106 is positioned to distribute thermal energy from a central loop of a thermally conductive coil toward an exterior loop of the thermally conductive coil. In another implementation, the set of thermally conductive fins 106 are arranged in a configuration defined by a 15 millimeter distance between each thermally conductive fin. However, the set of thermally conductive fins 106 can be arranged in any other configuration that enables thermal energy distribution about the sorbent chamber 118 and/or the set of sorbent beds 120.

In one implementation, the set of thermally conductive fins 106 is manufactured using a set of jigs (e.g., plates) configured to reduce warping of the set of thermally conductive fins 106. For example, the set of jigs can include aligning plates configured to retain the set of thermally conductive fins 106 within a target orientation such as to reduce warping during heating or cooling of the thermally conductive fins.

### 6. Purging Subsystem

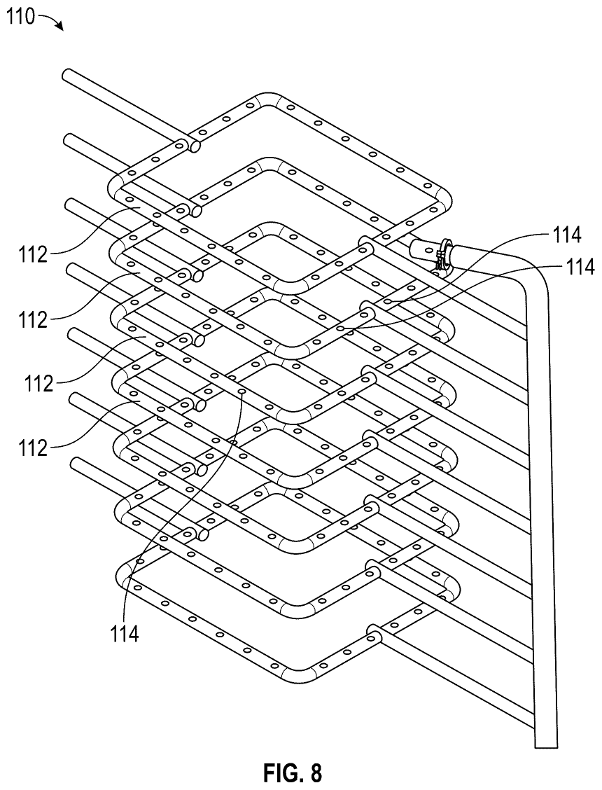

As shown in FIG. 8, the DAC system 100 generally includes a purging subsystem 110 further including a set of purging coils 112 such that each purging coil 112 in the set of purging coils 112 is configured to distribute a purging fluid 116 (e.g., steam) via a set of purging nozzles 114 into a sorbent bed 120 within the sorbent chamber 118. More specifically, the purging subsystem 110 can include the set of purging coils 112 wherein each purging coil 112 is arranged above or below a sorbent bed in the set of sorbent beds 120, such that the purging coil 112 is positioned to dispense purging fluid 116 onto the sorbent bed 120.

The purging subsystem 110 includes purging coils arranged within the sorbent chamber 118 to directly flush the purging chamber with a gaseous purging fluid 116, which can be later separated from any carbon dioxide released during the desorption phase S106. Additionally, the purging subsystem 110 directly heats the sorbent within the sorbent beds by exposing the sorbent to the high-temperature (greater than 100 degrees Celsius) purging fluid 116. Thus, the purging subsystem 110 enables the desorption phase S106 of s-TVSA by enabling the transfer of the purging fluid 116 into the depressurized sorbent chamber 118.

In one implementation, as shown in FIG. 8, the purging subsystem 110 includes a set of purging coils 112 wherein each purging coil 112 is arranged below a sorbent bed 120 in the set of sorbent beds 120. In this implementation, each purging coil 112 defines a set of purging nozzles 114 oriented to dispense purging fluid 116 directly toward the vertically adjacent sorbent bed. In another implementation, the purging subsystem 110 includes a set of purging coils 112 wherein each purging coil 112 in the set of purging coils 112 is coupled above a sorbent bed 120 in the set of sorbent beds 120. In this implementation, each purging coil 112 defines a set of purging nozzles 114 configured to dispense purging fluid 116 toward the sorbent bed 120 (e.g., the purging nozzles dispense the purging fluid into the sorbent chamber in the direction of the sorbent). In the sorbent module 130 variation, each sorbent module 130 includes a purging coil 112 configured to dispense purging fluid 116 toward the sorbent bed 120 of the sorbent module.

Generally, each purging coil 112 defines a set of purging nozzles 114 configured to disperse the purging fluid 116 toward the sorbent bed. In one example, the set of purging nozzles 114 is defined or arranged on the underside of the purging coil 112 to enable direct dispensation of the purging fluid 116 into the sorbent bed below the purging coil. However, in another example, the set of purging nozzles is defined or arranged on a top side of the purging coil 112 to enable direct dispensation of the purging fluid into the sorbent bed above the purging coil 112. In one implementation, each purging nozzle 114 is a one-way valve configured to dispense the purging fluid 116 into the sorbent bed 120 in response to a threshold differential pressure between the interior of the purging coil 112 and the pressure of the sorbent chamber 118. However, the set of purging nozzles 114 can include any valve, nozzle, or aperture appropriate for the dispensation of a gaseous or liquid purging fluid 116.

Similar to the set of thermally conductive heating coils 104, in yet another implementation, the purging subsystem 110 can include mechanically or electromechanically actuated couplers to enable the removal of a purging coil 112 associated with (e.g., arranged directly above or below) a sorbent bed. In this implementation, a user may decouple a corresponding subset of couplers linking the subset of purging coils 112 to the exterior components of the purging subsystem 110.

Generally, the purging subsystem 110 is configured to circulate and dispense a purging fluid 116, as shown in FIG. 2. As described above, in one implementation, the conductive heating system is configured to circulate purging fluid 116 and/or thermally conductive heating fluid 108. Additionally, in one implementation, the purging subsystem 110 is configured to circulate and dispense purging fluid 116 and/or thermally conductive heating fluid 108. In one implementation, shown in FIG. 3, the purging fluid 116 and the thermally conductive heating fluid 108 are the same fluid. In this implementation, the purging subsystem 110 is fluidically connected to the conductive heating system (e.g., via a recirculation subsystem 146). Therefore, the DAC system 100 is configured to both heat and purge the sorbent beds using the same fluid by recirculating fluid from the conductive heating subsystem 102 into the purging subsystem 110.

### 7. Sorbent Beds

As shown in FIGS. 1A, 1B, 2, and 3, the DAC system 100 includes a set of sorbent beds configured to absorb carbon dioxide from a flow of inlet gas. Generally, the set of sorbent beds 120 is arranged radially around a vertical manifold 122 through which inlet gas can flow from an inlet duct 140 and to the set of sorbent beds 120. Each sorbent bed 120 includes a mesh floor characterized by a mesh diameter less than a minimum sorbent particle diameter, thereby suspending the sorbent layer between radial interstices in the set of radial interstices 124, enabling inlet gas to pass through the sorbent bed 120 and through the sorbent layer. The sorbent bed 120 is characterized by a depth sufficient to contain a sorbent layer between 15 and 30 millimeters deep. However, the sorbent bed 120 can define any depth depending on the type of sorbent and corresponding target sorbent layer depths. Thus, the sorbent bed 120 enables high surface area and low pressure drop carbon dioxide exchange between the inlet gas and the sorbent layer.

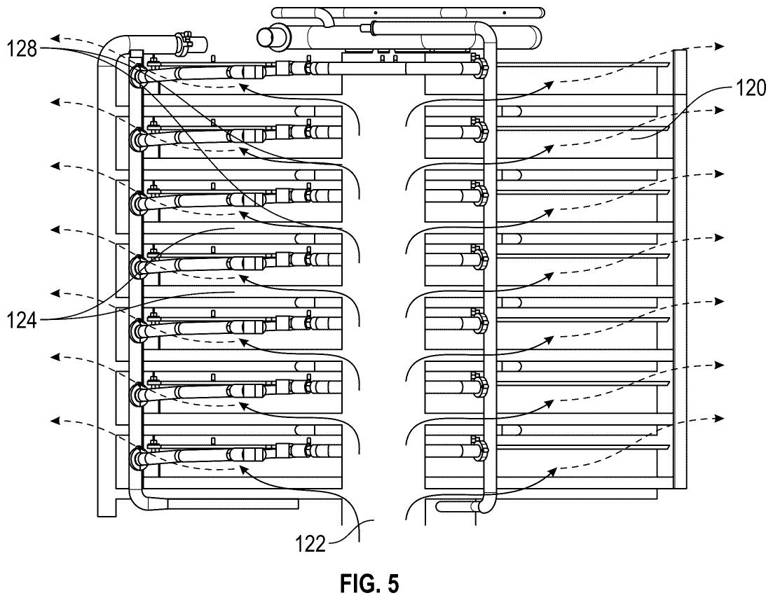

Generally, as shown in FIGS. 1A, 2, and 3, the set of sorbent beds 120: define a set of radial interstices between vertically adjacent sorbent beds in the set of sorbent beds 120; and extend radially about a vertical manifold 122 defining a set of manifold apertures 128, wherein each manifold aperture in the set of manifold apertures 128 fluidically connects the vertical manifold 122 to a radial interstice in the set of radial interstices 124. More specifically, the radial arrangement of the sorbent beds about the vertical manifold 122 reduces the pressure drop of inlet gas moving through the sorbent chamber 118 by creating a radial flow pattern. For example, as shown in FIG. 5, the radial flow pattern of inlet gas through the sorbent chamber 118 is such that inlet carbon dioxide-containing gas is forced into the vertical manifold 122 (e.g., arranged in the center or the set of sorbent beds 120), flows radially outward through a radial interstice in the set of radial interstices 124 (e.g., between vertically adjacent sorbent beds in the set of sorbent beds 120), through a sorbent bed 120 in the set of sorbent beds 120, into a circumferential manifold (e.g., between the set of sorbent beds 120 and a wall of the sorbent chamber 118), and out of the sorbent chamber 118. In this arrangement, each sorbent bed 120 includes a thin sorbent layer (e.g., 15-30 millimeters in depth) stacked closely together to ensure a high sorbent per-volume density within the sorbent chamber and minimize pressure drop across the system 118. In one implementation, the sorbent beds are vertically stacked with spacing greater than or equal to 90 mm between each sorbent bed.

In one implementation, the sorbent bed 120 defines a banked floor to facilitate condensation drainage away from the sorbent layer. In this implementation, the sorbent bed 120 can be characterized by a bank angle of up to ten degrees sufficient to cause condensation drainage under the force of gravity. In one example of this implementation, the sorbent bed 120 is banked toward the vertical manifold 122, causing condensation to drain into the vertical manifold 122 and/or out of the sorbent chamber 118 via the inlet damper 132 or outlet damper 138, whichever is arranged at the bottom of the sorbent chamber 118. Additionally or alternatively, the sorbent bed 120 is banked away from the vertical manifold 122, causing condensation to drain toward the exterior of the sorbent chamber 118 (i.e., the circumferential manifold) and out of the sorbent chamber 118 via the inlet damper 132 or outlet damper 138. Thus, the sorbent bed 120 can assist in condensation drainage from the sorbent layer, thereby increasing the adsorbing or absorbing efficiency of the sorbent layer and/or the longevity of the sorbent over many cycles of the method S100 for direct air capture.

In another implementation, the sorbent bed 120 defines a mesh geometry configured to induce fluidization within the sorbent layer at higher inlet gas flow rates (e.g., greater than 1.0 meters per second within the radial interstices). Thus, in this implementation, the sorbent bed 120 can enable increased exposure of the sorbent to the inlet gas via fluidization.

### 8. Sorbent Chamber

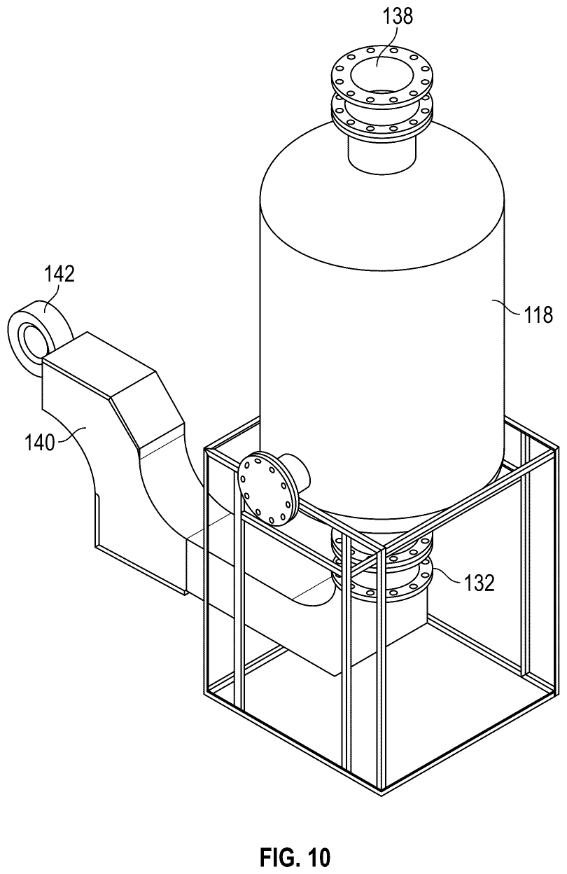

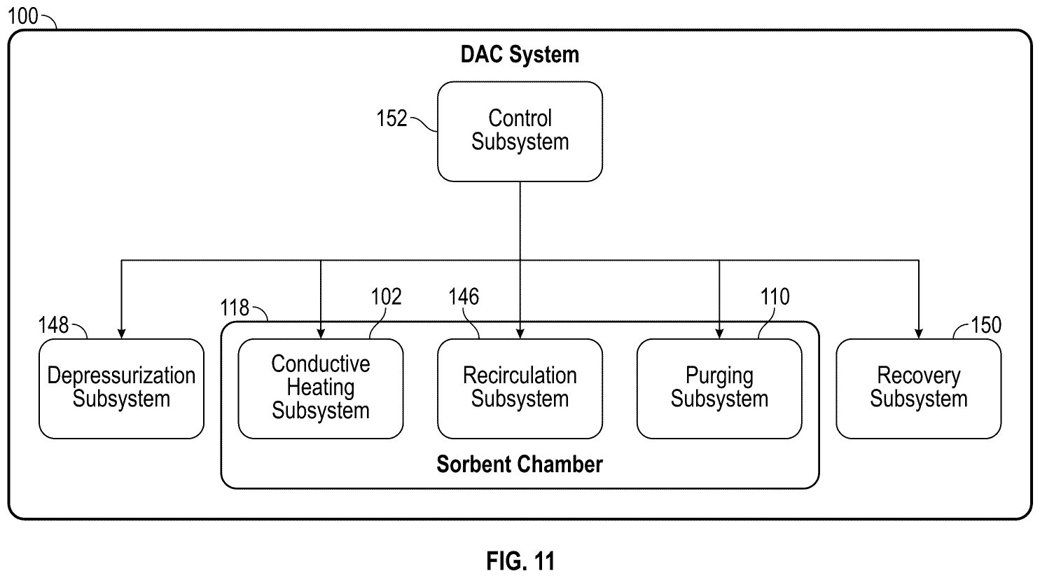

As shown in FIG. 10, the DAC system 100 includes a sorbent chamber 118 configured to house a set of vertically arranged sorbent beds 120. The sorbent chamber 118 defines a sealed pressure vessel configured to: house the set of sorbent beds 120, the conductive heating subsystem 102, and the purging subsystem 110; and withstand the varying pressures and temperatures of the sorption, vacuum-heating, and desorption phases. Therefore, the sorbent chamber 118 is configured to house the components of the DAC system 100 between a pressure of 0 millibars of vacuum pressure and up to 3.5 bars of internal pressure given normal atmospheric external ambient pressure between 0.990 and 1.013 bars.

Generally, the sorbent chamber 118 can be arranged in a top-down or bottom-up orientation. In the bottom-up orientation, the sorbent chamber 118 defines an inlet damper 132 at the bottom of the vertical manifold 122, such that inlet gas flows upward through the vertical manifold 122 and leaves the sorbent chamber 118 through an outlet damper 138 at the top of the sorbent chamber 118. In the top-down orientation, the sorbent chamber 118 defines an inlet damper 132 at the top of the vertical manifold 122, such that inlet gas flows downward through the vertical manifold 122 and leaves the sorbent chamber 118 through an outlet damper 138 at the bottom of the sorbent chamber 118. Thus, the sorbent chamber 118 can be positioned in either vertical orientation.

Generally, the sorbent chamber 118 defines an approximately ellipsoidal geometry. In one implementation, the sorbent chamber 118 includes an upper shell and a lower shell, each defining a flange at which the two components are couplable. For example, the sorbent chamber 118 can define ellipsoidal geometry in accordance with the ASME Section VIII Div 1-shell design and include a set of reinforcement pads around openings (such as the flanges, inlets, and outlets) for complete sealing.

In one implementation, the sorbent chamber 118 includes a vertical manifold 122 positioned near the center of the sorbent chamber 118 to enable radial flow outward from the vertical manifold 122. The vertical manifold 122 can be defined by a set of manifold segments of the set of sorbent beds 120 or sorbent modules. Alternatively, the sorbent chamber 118 defines a sleeve extending from the inlet damper 132 that defines the vertical manifold 122 and provides structural support for the vertically arranged sorbent beds, such that the set of sorbent beds is not entirely supported by the vertical manifold 122 itself.

Generally, the vertical manifold 122 of the sorbent chamber 118 can include a set of manifold apertures 128 (e.g., spacing between vertically adjacent sorbent beds) to enable inlet gas to escape from the vertical manifold 122 into the radial interstices and, subsequently, into the sorbent beds. The set of manifold apertures 128 can include manifold apertures spaced at regular vertical intervals along the vertical manifold 122. Additionally, the set of manifold apertures 128 can include apertures of variable size to adjust inlet gas flow distribution through the set of radial interstices 124.

In another implementation, the vertical manifold 122 can define a tapering cross-section to restrict the flow of inlet gas as the vertical distance from the sorbent chamber 118 inlet increases, thereby increasing the flow of inlet gas into radial interstices closer to the inlet damper 132 relative to implementations defining a vertical manifold 122 characterized by a constant cross-sectional area.

In yet another implementation, the vertical manifold 122 is configured to receive inlet gas flows via the inlet damper 132 at flow velocities between 6.0 and 15.0 meters per second, resulting in average flow velocities across the sorbent beds in the set of sorbent modules 130 between 5 centimeters per second and 1.2 meters per second. In some implementations, the sorbent chamber 118 is configured to receive an inlet gas flow rate capable of causing fluidization of the sorbent layer within the set of sorbent beds 120, which generally occurs at flow rates of greater than 1.0 meters per second for sorbent layers between 15 and 30 millimeters in depth for sorbents with an average particle diameter of approximately 150 microns.

In yet another implementation, the sorbent chamber 118 is characterized by a pressure drop between the inlet and outlet damper 138 between 134 and 414 pascals (depending on the porosity of the sorbent beds) for a 43-centimeter-per-second flow velocity across the sorbent beds. Thus, the radial flow sorbent chamber 118 is characterized by a significantly lower pressure drop than many axial flow alternatives.

### 9. Inlet and Outlet Dampers

Generally, the sorbent chamber 118 includes an inlet damper 132 and an outlet damper 138, each configured to: occupy an open configuration to allow flow of gas into and out of the sorbent chamber 118; and occupy a closed configuration to seal the sorbent chamber 118. When the inlet damper 132 and the outlet damper 138 occupy a closed configuration, the sorbent chamber 118 defines an airtight evacuable volume (e.g., to a pressure of 80 millibars or less by the depressurization subsystem 148 during the desorption phase S106).

More specifically, the inlet damper 132 is configured to transmit a fluid into the vertical manifold 122 of the sorbent chamber 118, and the outlet damper 138 is configured to release the fluid from the sorbent chamber 118 to an ambient environment. As shown in FIG. 10, the DAC system 100 can include an inlet damper 132 and an outlet damper 138 configured to selectively admit inlet gas into the sorbent chamber 118 and allow outlet gas to escape the sorbent chamber 118 upon sorption of carbon dioxide by the sorbent layers, respectively. More specifically, the DAC system 100 can include: an inlet damper 132 configured to admit inlet gas into the vertical manifold 122 of the sorbent chamber 118; and an outlet damper 138 arranged opposite the inlet damper 132 in the sorbent chamber 118. In particular, the inlet damper 132 and the outlet damper 138 can maintain a pressure differential between the interior and exterior of the sorbent chamber 118 of greater than 1.0 atmosphere or 1.014 bar. Thus, the DAC system 100 includes an inlet damper 132 and an outlet damper 138 that enables the intended inlet gas flow pattern through the sorbent chamber 118 (i.e., into the vertical manifold 122, into the set of radial interstices 124, through the set of sorbent beds 120, and out of the outlet damper 138).

The inlet damper 132 and/or the outlet damper 138 can be mechanically, hydraulically, or electromechanically actuated such that the inlet damper 132 and/or the outlet damper 138 can be opened or closed via signals transmitted from the control subsystem 152.

In one implementation (e.g., a bottom-up orientation), the DAC system 100 includes the inlet damper 132 below the sorbent chamber 118 such that inlet gas enters the sorbent chamber 118 from the bottom of the sorbent chamber 118 and flows upward through the vertical manifold 122 into the radial interstices. In this implementation, the DAC system 100 includes the outlet damper 138 at the top of the sorbent chamber 118, and condensation from the set of sorbent beds 120 can drain out through the inlet damper 132 under the force of gravity.

In another implementation (e.g., a top-down orientation), the DAC system 100 includes the outlet damper 138 below the sorbent chamber 118 and the inlet damper 132 at the top of the sorbent chamber 118. Thus, in this implementation, inlet gas enters the sorbent chamber 118 from above the sorbent chamber 118 and flows downward through the vertical manifold 122 and into the radial interstices, and condensation can drain out of the sorbent chamber 118 through the outlet damper 138.

In yet another implementation, the DAC system 100 can include an inlet carbon dioxide sensor arranged at the inlet damper 132 and an outlet carbon dioxide sensor arranged at the outlet damper 138. In this implementation, the inlet carbon dioxide sensor and the outlet carbon dioxide sensor are configured to measure an inlet carbon dioxide concentration and an outlet carbon dioxide concentration, respectively. Thus, in this implementation, the DAC system 100 can indirectly measure the saturation of the sorbent within the sorbent chamber 118 based on the difference between the inlet carbon dioxide concentration and the outlet carbon dioxide concentration (i.e., lower differences between the inlet carbon dioxide concentration and the outlet carbon dioxide concentration indicate increasing saturation of the sorbent with carbon dioxide).

### 10. Blower

As shown in FIG. 10, the DAC system 100 can include a blower 142 fluidically coupled to an inlet damper 132 (e.g., via an inlet duct 140 further described below) and configured to flow inlet gas into the sorbent chamber 118. Generally, the blower 142 is arranged outside of the sorbent chamber 118 and upstream from the inlet damper 132. The blower is configured to generate an inlet pressure at the inlet damper 132 sufficient to overcome the pressure drop of the sorbent chamber 118. The blower can further accelerate the inlet gas to a target inlet gas velocity (e.g., up to 15 meters per second) that results in efficient carbon dioxide absorption with the sorbent chamber 118. More specifically, the blower 142 can be a fan, compressor, or any other mechanism capable of directing inlet gas toward the inlet damper 132.

### 11. Inlet Duct

As shown in FIG. 10, the DAC system 100 can include an inlet duct 140 fluidically coupled to the inlet damper 132 and configured to direct inlet gas from a blower 142 to the inlet damper 132 of the sorbent chamber 118. In implementations in which the inlet damper 132 is arranged at the bottom of the sorbent chamber 118 (e.g., a bottom-up configuration), the inlet duct 140 is configured to receive condensed purging fluid 116 (e.g., water) that drains from the sorbent chamber 118. In this implementation, the inlet duct 140 is configured to drain or funnel the condensed purging fluid 116 for regeneration into the purging subsystem 110. However, the inlet duct 140 may alternatively be coupled to a top of the sorbent chamber 118 such that the condensed purging fluid 116 drains toward the outlet damper 138. Thus, the inlet duct 140 is arranged to enable the blower 142 to accelerate inlet gas into the sorbent chamber 118.

### 12. Depressurization Subsystem

Generally, as shown in FIG. 11, the DAC system 100 includes a depressurization subsystem 148 configured to reduce the absolute pressure within the sorbent chamber 118 to 80 millibars or less. In one implementation, the depressurization subsystem 148 is fluidically connected to the sorbent chamber 118 via a depressurization valve, which can be electromechanically actuated by the control subsystem 152. The depressurization subsystem 148 can further include a vacuum pump (e.g., a rotary vacuum pump) configured to pump gas out of the sorbent chamber 118 via the depressurization valve. Thus, the DAC system 100 includes the depressurization subsystem 148 to evacuate or partially evacuate the sorbent chamber 118 of gas after the sorption phase S102.

### 13. Recovery Subsystem

Generally, as shown in FIG. 11, the DAC system 100 includes a recovery subsystem 150 (e.g., a carbon dioxide and heat recovery subsystem 150) fluidically connected to the sorbent chamber 118 via a recovery valve and configured to recover carbon dioxide desorbed from the sorbent during the desorption phase S106. The recovery subsystem 150 can include: a recovery valve, which can be electromechanically actuated by the control subsystem 152; a pump to remove the mixture of desorbed carbon dioxide and purging fluid 116 from the sorbent chamber 118 via the recovery valve; a condenser to condense the purging fluid 116 for recovery and reuse by the purging subsystem 110; and a compressor to pressurize and store desorbed carbon dioxide. Additionally or alternatively, the recovery subsystem 150 can include additional elements utilized for carbon dioxide recovery in s-TSVA direct air capture. Thus, the recovery subsystem 150 enables the recovery and reuse of the purging fluid 116 and the separation and storage of high-purity carbon dioxide.

### 14. Recirculation Subsystem

In one implementation, the DAC system 100 includes a recirculation subsystem 146 configured to recirculate thermally conductive heating fluid 108 from the conductive heating subsystem 102 as purging fluid 116 for the purging subsystem 110. In one implementation, the recirculation subsystem is configured to recirculate purging fluid 116 from the purging subsystem 110 as thermally conductive heating fluid 108 for the conductive heating subsystem 102. More specifically, as shown in FIG. 3, the recirculation subsystem 146 can include one or more of a recovery pipe, a recovery pump, and a fluid heater. In one implementation, the recirculation subsystem 146 is configured to connect the set of thermally conductive heating coils 104 to the set of purging coils 112 such that the thermally conductive heating fluid 108 from the conductive heating subsystem 102 can be recycled for use as the purging fluid 116 for the purging subsystem 110 and the opposite. Therefore, the recovery subsystem 150 can further recover and recycle heated fluid from the conductive heating subsystem 102 to heat the purging fluid 116 or use as the purging fluid 116 of the purging subsystem 110.

### 15. System Assembly

Generally, the DAC system 100 includes a conductive heating subsystem 102, a purging subsystem 110, and a set of sorbent beds wholly or partially contained within the sorbent chamber 118. More specifically, the DAC system 100 includes a set of vertically stacked sorbent beds with a thermally conductive heating coil 104 and a purging coil 112 arranged within, above, or below each sorbent bed in the set of sorbent beds 120. In one implementation, the set of sorbent beds 120 extends radially from a vertical manifold 122 through which fluid can travel from the inlet duct 140, across the sorbent beds, and to the outlet duct. In another implementation, the system 100 includes a set of sorbent beds that themselves define the vertical manifold 122 based on a series of stacked manifold segments. Each of these implementations is described in further detail below. Thus, the conductive heating subsystem 102, purging subsystem 110, and the set of sorbent beds 120 are assembled in a configuration enabling radial flow of inlet gas over the sorbent in each sorbent bed.

### 15.1. Manifold Segments and Manifold Attachment Mechanism

In one implementation, each sorbent bed 120 in the set of sorbent beds 120 (e.g., a sorbent bed 120 optionally including an embedded purging coil 112 or thermally conductive heating coil) can include a manifold segment or a manifold attachment mechanism, which supports the sorbent bed 120 in a radially cantilevered configuration. In this implementation, the sorbent bed 120 includes a manifold segment that, together with the manifold segments of other sorbent beds, defines the vertical manifold 122. More specifically, each manifold segment supports the sorbent bed 120 of which it is a part, and each of the sorbent beds above that manifold segment within the sorbent chamber 118. Thus, in this implementation, the vertical manifold 122 is defined by a stacked set of manifold segments.

In another implementation, the sorbent bed 120 attaches to a sleeve extending vertically within the sorbent chamber 118 from the inlet damper 132. In this implementation, the sleeve bears the load in the set of sorbent beds 120 via a set of manifold attachment mechanisms that couple each of the sorbent beds to the sleeve. In this implementation, each attachment mechanism bears the weight of the associated sorbent bed 120 and does not bear the weight of other sorbent beds, enabling greater interchangeability of beds within the sorbent chamber 118.

In implementations in which each sorbent bed 120 includes a manifold segment defining the vertical manifold 122, each sorbent bed 120 can further include a manifold coupling mechanism to securely couple and decouple each manifold segment to manifold segments above and below. Additionally, in this implementation, each coupling mechanism can be released to enable users to remove the sorbent beds from the sorbent chamber 118.

In implementations in which each sorbent bed 120 includes a manifold attachment mechanism, each sorbent bed 120 can further include a coupling mechanism configured to couple or decouple each sorbent bed 120 to the vertical manifold 122, enabling the removal of each sorbent bed 120 from the sorbent chamber 118.

### 15.2. Sorbent Support Structure

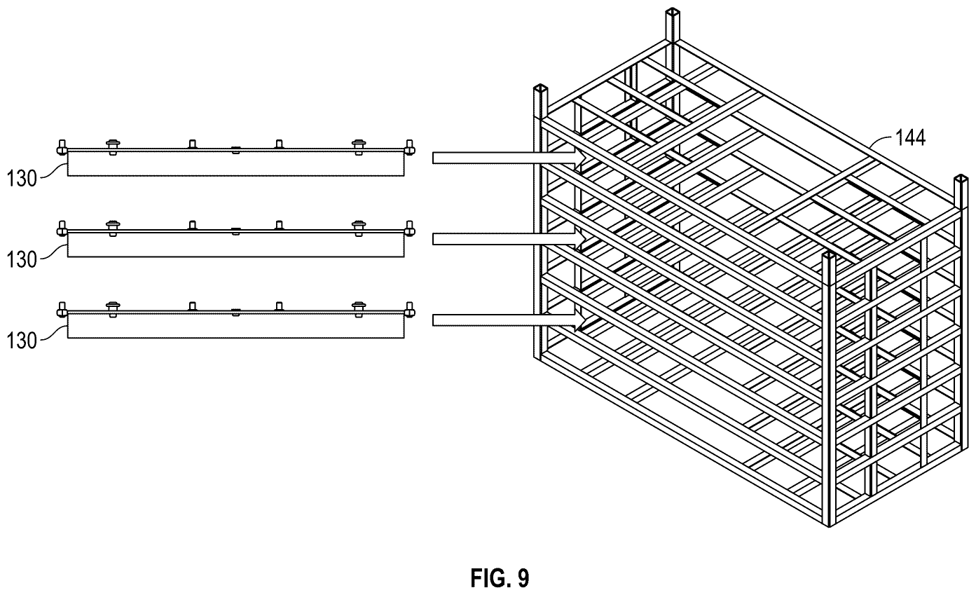

In one implementation, as shown in FIG. 9, the DAC system 100 can additionally include a sorbent support structure 144 arranged within the sorbent chamber 118 and configured to support each sorbent bed 120 in the set of sorbent beds 120. The sorbent support structure 144 can function in cooperation with the manifold attachment mechanisms described above to provide support for each sorbent bed. However, the sorbent support structure 144 can additionally function as an alternative to the manifold attachment mechanisms and other support modalities to independently support the set of sorbent beds 120.

In one implementation, the sorbent support structure 144 defines a set of sorbent supports configured to support each sorbent module 130 in the set of sorbent modules 130. For example, the sorbent support structure 144 can function as a shelving unit configured to receive one or more sorbent beds on each shelf (e.g., each sorbent support). In this implementation, each sorbent bed 120 in the set of sorbent beds 120 (and/or each sorbent module 130 in the set of sorbent modules 130) is independently decouplable from an assembly of other sorbent beds (or sorbent modules) such as by removing the sorbent bed 120 (or sorbent module) from the sorbent support and from the sorbent chamber 118. Therefore, the sorbent support structure 144 facilitates maintenance, cleaning, and repair of the DAC system 100 by enabling the removal of individual sorbent beds without disturbing the remaining sorbent beds.

In another implementation, the sorbent support structure 144 can additionally support other components of the DAC system 100, such as the thermally conductive heating coils and/or the purging coils. For example, the sorbent support structure can define a set of sorbent supports wherein each sorbent support includes an attachment mechanism for a purging coil 112. In this example, the attachment mechanism retains the purging coil 112 in a target position above a sorbent bed 120 for the purging nozzles 114 of the purging coil 112 to distribute purging fluid 116 toward the sorbent bed 120 (e.g., the purging nozzles dispense the purging fluid into the sorbent chamber in the direction of the sorbent bed). Further, the sorbent support structure 144 can retain or support the set of thermally conductive coils within or adjacent to a sorbent bed 120 for effective conduction of thermal energy to the sorbent bed.

### 15.3. Assembly Variation: Sorbent Modules

In one variation, the DAC system 100 includes a set of sorbent modules 130, each sorbent module 130 including a thermally conductive heating coil 104 of the thermally conductive heating subsystem 102, a purging coil 112 of the purging subsystem 110, and a sorbent bed. More specifically, the set of sorbent modules 130 arranges vertically within the sorbent chamber 118 and extends radially from the vertical manifold 122. The set of sorbent modules 130 defines the vertical manifold 122 and the set of radial interstices 124 between vertically adjacent sorbent modules in the set of sorbent modules 130. Each sorbent module 130 includes: a vertical manifold 122 segment of the vertical manifold 122 defining a set of manifold apertures 128 fluidically connecting the vertical manifold 122 to a radial interstice in the set of radial interstices 124; a sorbent bed 120 extending radially from the vertical manifold 122 segment and associated with a purging coil 112 in the set of purging coils 112 configured to distribute the purging fluid 116 into the sorbent bed; and a thermally conductive heating coil 104 in the set of thermally conductive heating coils 104 arranged within the sorbent bed. In this variation, each sorbent module 130 can be independently removable from the sorbent support structure 144, such as for maintenance of the sorbent bed, purging coil, and/or thermally conductive heating coil 104 of the sorbent model.

In one implementation, as shown in FIG. 6, the sorbent chamber 118 can include a set of sorbent modules 130 that extend radially from the vertical manifold 122 and define radial interstices through which inlet gas may flow before passing through the sorbent beds. More specifically, each sorbent module 130 in the set of sorbent modules 130 includes a manifold segment or attachment, a sorbent bed, a thermally conductive heating coil, and a purging coil. In particular, the sorbent chamber 118 includes sorbent modules that can be removed either individually or in subsets to facilitate sorbent replacement, the removal of condensation, and/or other maintenance. Thus, the modularity of the sorbent modules can enable many of the advantages of the DAC system 100, including the low-pressure drop and ease of maintenance.

In one implementation, the set of sorbent modules 130 of this variant can define the vertical manifold 122 via each sorbent module 130 including a manifold segment or a manifold attachment mechanism, which supports the sorbent module 130 in a radially cantilevered configuration. Thus, in this implementation, the vertical manifold 122 is defined by a stacked set of manifold segments.

In another implementation, each sorbent module 130 in the set of sorbent modules 130 attaches to a sleeve extending vertically within the sorbent chamber 118 from the inlet damper 132. In this implementation, the sleeve bears the load in the set of sorbent modules 130 via a set of manifold attachment mechanisms that couple each of the sorbent modules to the sleeve.

In implementations in which each sorbent module 130 includes a manifold segment defining the vertical manifold 122, each sorbent module 130 can further include a manifold coupling mechanism to securely couple and decouple each manifold segment to manifold segments above and below. Additionally, in this implementation, each coupling mechanism can be released to enable users to remove the sorbent modules from the sorbent chamber 118. Further, each sorbent module 130 can further include a coupling mechanism configured to couple or decouple each sorbent module 130 to the vertical manifold 122, enabling the removal of each sorbent module 130 from the sorbent chamber 118.

Generally, each sorbent module 130 in the set of sorbent modules 130 can include one or more thermally conductive heating coils, in the set of thermally conductive heating coils 104 described above, arranged within the sorbent bed. The thermally conductive heating coils within the sorbent module 130 enable the DAC system 100 to preheat the sorbent layer before and/or during the desorption phase S106 of the method S100 for direct air capture. Thus, the DAC system 100 can minimize the quantity of condensation that occurs within each sorbent module 130 during the desorption phase S106 by reducing the difference in temperature between the sorbent and the incoming purging fluid 116.

Generally, each sorbent module 130 is self-contained. For example, each sorbent module 130 provides a purging coil 112 and a thermally conductive heating coil 104 for the sorbent bed 120 of the sorbent module. For example, the sorbent module 130 can include: a purging coil 112 arranged above or below the sorbent bed 120 of the sorbent module 130, such that the purging coil 112 can dispense purging fluid 116 toward the sorbent bed 120 via the purging nozzles 114; and a thermally conductive heating coil 104 arranged within the sorbent bed to heat the sorbent layer. Thus, in this implementation, complexity in assembling the set of sorbent modules 130 within the sorbent chamber may be reduced relative to the aforementioned implementation in which the sorbent beds, purging coils, and thermally conductive heating coils are assembled and installed separately.

In one implementation, each sorbent module 130 includes a purging coil 112 arranged beneath the sorbent bed 120 and configured to dispense the purging fluid 116 directly into the sorbent bed 120 vertically adjacent to and below the sorbent module. In this implementation, the bottom-most sorbent module 130 in the set of vertically arranged sorbent modules excludes a purging coil, as no sorbent bed 120 exists below this sorbent module. Additionally or alternatively, in this implementation, the top-most sorbent module 130 can be arranged below an independent purging coil 112 not attached to another sorbent module. In this implementation, the sorbent module 130 minimizes additional structures required to position the purging coil 112 above the sorbent bed 120 by attaching the purging coil 112 to the immediately adjacent sorbent module 130 above the sorbent module. In another implementation, each sorbent module 130 includes a purging coil 112 arranged above the sorbent bed 120 and configured to dispense the purging fluid 116 directly into the sorbent bed.

### 16. Control Subsystem and Method

Generally, the DAC system 100 can include a control subsystem configured to actuate the electromechanical components of the DAC system 100 in order to execute a method S100 for direct air capture of carbon dioxide. More specifically, the control subsystem includes a computational device, executing computer-readable instructions, that is configured to transmit control signals to the inlet damper 132, the outlet damper 138, the blower 142, the depressurization subsystem 148 (including the depressurization valve), the recovery subsystem 150 (the recovery valve), the conductive heating subsystem 102, and the purging subsystem 110 to execute Steps of the method S100 for direct air capture of carbon dioxide. Additionally, the control subsystem can receive data from the inlet carbon dioxide sensor, the outlet carbon dioxide sensor, a pressure sensor within the sorbent chamber 118, a set of temperature sensors within the sorbent chamber 118, and/or any other sensor that facilitates execution of the method S100 for direct air capture of carbon dioxide. Thus, the control subsystem 152 coordinates the physical components of the DAC system 100 to effectively remove carbon dioxide from the inlet gas.

Generally, as shown in FIG. 2, the method S100 for direct air capture of carbon dioxide via the DAC system 100 includes, during a sorption phase S102: opening the inlet damper 132; opening the outlet damper 138; and operating the blower 142 to generate a flow of carbon dioxide-containing gas through the inlet duct 140, the inlet damper 132, the vertical manifold 122, the set of radial interstices 124, the sorbent bed 120 of each sorbent module 130 in the set of sorbent modules 130, and out of the outlet damper 138. The method S100 also includes, in response to detecting the outlet carbon dioxide concentration within a threshold carbon dioxide concentration of the inlet carbon dioxide concentration, during a vacuum-heating phase S104: closing the inlet damper 132; closing the outlet damper 138; opening the depressurization valve; operating the depressurization subsystem 148 to depressurize the sorbent chamber 118; and operating the conductive heating subsystem 102 to heat sorbent within the sorbent bed 120 of each sorbent module 130 in the set of sorbent modules 130. The method S100 additionally includes, in a desorption phase S106 subsequent to the vacuum-heating phase S104: closing the depressurization valve; operating the purging subsystem 110 to purge the sorbent chamber 118; opening the recovery valve; and operating the carbon dioxide and heat recovery subsystem 150 to recover heat and gaseous carbon dioxide from a carbon dioxide and steam mixture exiting the sorbent chamber 118 via the recovery valve.

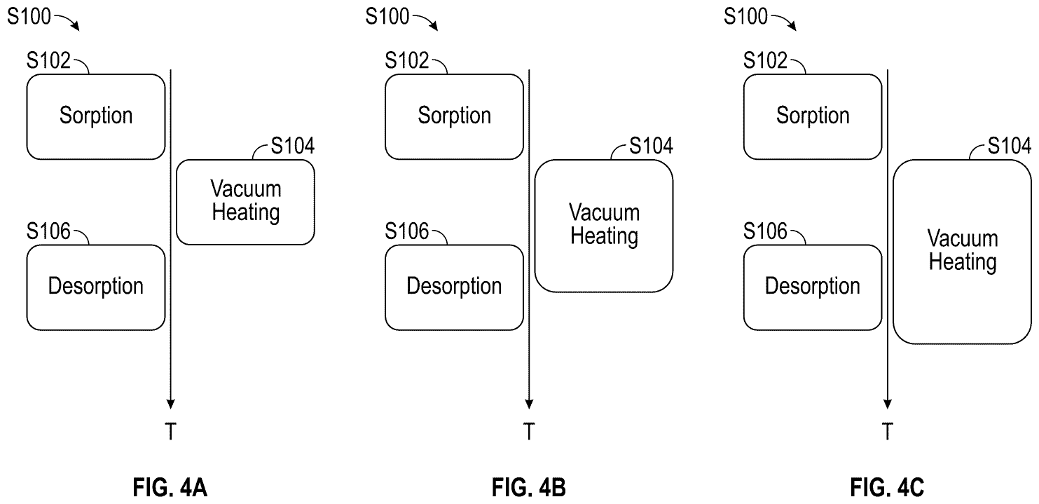

In one implementation, the control subsystem 152 of the DAC system is configured to perform any of the steps or phases described above in any order to accomplish capture of carbon dioxide. For example, after executing the sorption phase S102, the control subsystem 152 may repeatedly execute the vacuum-heating phase S104 and/or the desorption phase S106 to increase an amount of carbon dioxide purged from the sorbent. As shown in FIGS. 4A, 4B, and 4C, the control subsystem 152 can execute the method S100 such that the phases occur serially or simultaneously or overlap in duration. For example, as shown in FIG. 4A, the method S100 may consist of the sorption phase S102, followed by the vacuum-heating phase, and completed by the desorption phase S106, each executed serially. However, in one implementation as shown in FIG. 4B, the vacuum-heating phase S104 begins before the desorption phase S106 but can continue after the desorption phase S106 begins, such as to continue heating the sorbent to prevent condensation staying within the sorbent. In another implementation, as shown in FIG. 4C, the vacuum-heating phase S104 again begins before the desorption phase S106 but continues during and after the desorption phase S106, such as to dry out the sorbents before another capture cycle occurs. The control subsystem 152 can alter the steps occurring within a phase and the timing/ordering of the phases, such as in response to user input or sensor data from the DAC system 100.

### Additional Considerations

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented, at least in part, as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer-readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A direct air capture system comprising:
a conductive heating subsystem comprising:
a set of thermally conductive heating coils;
a purging subsystem comprising a set of purging coils configured to distribute a purging fluid via a set of purging nozzles; and
a sorbent chamber enclosing a set of sorbent modules vertically arranged within the sorbent chamber, the set of sorbent modules defining a vertical manifold and a set of radial interstices between vertically adjacent sorbent modules in the set of sorbent modules and extending radially from the vertical manifold, each sorbent module in the set of sorbent modules comprising:
a vertical manifold segment of the vertical manifold defining a set of manifold apertures fluidically connecting the vertical manifold to a radial interstice in the set of radial interstices;
a sorbent bed extending radially from the vertical manifold segment and associated with a purging coil in the set of purging coils configured to distribute the purging fluid into the sorbent bed; and
a thermally conductive heating coil in the set of thermally conductive heating coils arranged within the sorbent bed.

2. The direct air capture system of claim 1, further comprising:
an inlet damper configured to transmit a fluid into the vertical manifold of the sorbent chamber;
an inlet carbon dioxide sensor configured to detect an inlet carbon dioxide concentration of the fluid within the inlet damper;
an outlet damper configured to release the fluid from the sorbent chamber to an ambient environment; and
an outlet carbon dioxide sensor configured to detect an outlet carbon dioxide concentration of the fluid within the outlet damper.

3. The direct air capture system of claim 2, further comprising:
an inlet duct fluidically coupled to the inlet damper; and
a blower:
fluidically connected to the inlet duct; and
arranged upstream from the inlet damper.

4. The direct air capture system of claim 1, further comprising:
an inlet damper configured to transmit a fluid into the vertical manifold of the sorbent chamber;
an inlet carbon dioxide sensor configured to detect an inlet carbon dioxide concentration of the fluid within the inlet damper;
an outlet damper configured to release the fluid from the sorbent chamber to an ambient environment;
an inlet carbon dioxide sensor configured to detect an inlet carbon dioxide concentration of the fluid within the inlet damper;
an inlet duct fluidically coupled to the inlet damper;
a blower fluidically connected to the inlet duct and arranged upstream from the inlet damper;
a depressurization subsystem fluidically connected to the sorbent chamber via a depressurization valve;
a carbon dioxide and heat recovery subsystem fluidically connected to the sorbent chamber via a recovery valve; and
a control subsystem.

5. The direct air capture system of claim 4, wherein the control subsystem is further configured to:
during a sorption phase:
open the inlet damper;
open the outlet damper; and
operate the blower to generate a flow of carbon-dioxide-containing gas through the inlet duct, the inlet damper, the vertical manifold, the set of radial interstices, the sorbent bed of each sorbent module in the set of sorbent modules, and out of the outlet damper;
in response to detecting the outlet carbon dioxide concentration within a threshold carbon dioxide concentration of the inlet carbon dioxide concentration, during a vacuum-heating phase:
close the inlet damper;
close the outlet damper;
open the depressurization valve;
operate the depressurization subsystem to depressurize the sorbent chamber; and
operate the conductive heating subsystem to heat sorbent within the sorbent bed of each sorbent module in the set of sorbent modules; and
in a desorption phase subsequent to the vacuum-heating phase:
close the depressurization valve;
operate the purging subsystem to purge the sorbent chamber;
open the recovery valve; and
operate the carbon dioxide and heat recovery subsystem to recover heat and gaseous carbon dioxide from a carbon dioxide and steam mixture exiting the sorbent chamber via the recovery valve.

6. The direct air capture system of claim 1, wherein the sorbent bed of each sorbent module in the set of sorbent modules defines a mesh floor characterized by a mesh diameter less than a minimum particle diameter of a sorbent.

7. The direct air capture system of claim 1, wherein the set of sorbent modules is assembled in a sorbent module assembly and each sorbent module in the set of sorbent modules is independently decouplable from the sorbent module assembly.

8. The direct air capture system of claim 1, wherein the set of sorbent modules is assembled in a stacked sorbent module configuration.

9. The direct air capture system of claim 1, further comprising a sorbent support structure defining a set of sorbent supports configured to support each sorbent module in the set of sorbent modules.

10. The direct air capture system of claim 1, wherein the conductive heating subsystem circulates the purging fluid, as a thermally conductive heating fluid, through the set of thermally conductive heating coils.

11. The direct air capture system of claim 1, wherein the conductive heating subsystem further comprises a set of thermally conductive fins configured to distribute thermal energy from the set of thermally conductive heating coils, wherein a subset of thermally conductive fins in the set of thermally conductive fins is configured to distribute thermal energy to the sorbent bed.

12. A direct air capture system comprising:
a sorbent chamber housing a set of sorbent beds:
arranged vertically within the sorbent chamber;
defining a set of radial interstices between vertically adjacent sorbent beds in the set of sorbent beds; and
wherein each sorbent bed in the set of sorbent beds extends radially about a vertical manifold, the vertical manifold defining a set of manifold apertures, and each manifold aperture in the set of manifold apertures fluidically connecting the vertical manifold to a radial interstice in the set of radial interstices;
a conductive heating subsystem comprising:
a set of thermally conductive heating coils arranged within the sorbent chamber, each thermally conductive heating coil in the set of thermally conductive heating coils:
arranged within a sorbent bed in the set of sorbent beds; and
configured to circulate a thermally conductive heating fluid to heat the sorbent bed; and
a purging subsystem comprising a set of purging coils, each purging coil:
configured to distribute a purging fluid via a set of purging nozzles to a sorbent bed in the set of sorbent beds; and
arranged above the sorbent bed in the set of sorbent beds.

13. The direct air capture system of claim 12, further comprising a sorbent support structure defining a set of sorbent supports configured to support each sorbent bed in the set of sorbent beds.

14. The direct air capture system of claim 12, wherein each sorbent bed in the set of sorbent beds is individually removable from the sorbent chamber.

15. The direct air capture system of claim 12, wherein the conductive heating subsystem circulates the purging fluid, as a thermally conductive heating fluid, through the set of thermally conductive heating coils.

16. The direct air capture system of claim 12, wherein the conductive heating subsystem further comprises a set of thermally conductive fins, each thermally conductive fin in the set of thermally conductive fins:
arranged within a sorbent bed in the set of sorbent beds; and
configured to distribute thermal energy to the sorbent bed in the set of sorbent beds.

17. The direct air capture system of claim 12, further comprising:
an inlet damper configured to transmit a fluid into the vertical manifold of the sorbent chamber;
an inlet carbon dioxide sensor configured to detect an inlet carbon dioxide concentration of the fluid within the inlet damper;
an outlet damper configured to release the fluid from the sorbent chamber to an ambient environment; and
an outlet carbon dioxide sensor configured to detect an outlet carbon dioxide concentration of the fluid within the outlet damper.

18. The direct air capture system of claim 17, further comprising:
an inlet duct fluidically coupled to the inlet damper; and
a blower:
fluidically connected to the inlet duct; and
arranged upstream from the inlet damper.

19. The direct air capture system of claim 12, further comprising:
an inlet damper configured to transmit a fluid into the vertical manifold of the sorbent chamber;
an inlet carbon dioxide sensor configured to detect an inlet carbon dioxide concentration of the fluid within the inlet damper;
an outlet damper configured to release the fluid from the sorbent chamber to an ambient environment;
an inlet carbon dioxide sensor configured to detect an inlet carbon dioxide concentration of the fluid within the inlet damper;
an inlet duct fluidically coupled to the inlet damper;
a blower fluidically connected to the inlet duct arranged upstream from the inlet damper;
a depressurization subsystem fluidically connected to the sorbent chamber via a depressurization valve; and
a carbon dioxide and heat recovery subsystem fluidically connected to the sorbent chamber via a recovery valve.

20. The direct air capture system of claim 19, further comprising a control subsystem configured to:
during a sorption phase:
open the inlet damper;
open the outlet damper; and
operate the blower to generate a flow of carbon-dioxide-containing gas through the inlet duct, the inlet damper, the vertical manifold, the set of radial interstices, the sorbent bed of each sorbent module in the set of sorbent modules, and out of the outlet damper;
in response to detecting the outlet carbon dioxide concentration within a threshold carbon dioxide concentration of the inlet carbon dioxide concentration, during a vacuum-heating phase:
close the inlet damper;
close the outlet damper;
open the depressurization valve; and
operate the depressurization subsystem to depressurize the sorbent chamber; and
operate the conductive heating subsystem to heat sorbent within the sorbent bed of each sorbent module in the set of sorbent modules; and
in a desorption phase subsequent to the vacuum-heating phase:
close the depressurization valve;
operate the purging subsystem to purge the sorbent chamber;
open the recovery valve; and
operate the carbon dioxide and heat recovery subsystem to recover heat and gaseous carbon dioxide from a carbon dioxide and steam mixture exiting the sorbent chamber via the recovery valve.
